(19) United States
(12) Patent Application Publication
(10) Pub. No.: US 2022/0236560 A1
(43) Pub. Date: Jul. 28, 2022

(54) HEAD-UP DISPLAY

(71) Applicant: NIPPON SEIKI CO., LTD., Niigata (JP)

(72) Inventors: Yasushi AKIYAMA, Niigata (JP); Akira TANAKAJIMA, Niigata (JP); Kouki SAKAUE, Niigata (JP)

(21) Appl. No.: 17/616,565

(22) PCT Filed: Jun. 4, 2020
(86) PCT No.: PCT/JP2020/022122

§ 371 Date: Dec. 3, 2021

(30) Foreign Application Priority Data
Jun. 6, 2019 (JP) 2019-106535
Aug. 7, 2019 (JP) 2019-145428
Aug. 8, 2019 (JP) 2019-146244

(51) Int. Cl. G02B 27/01; B60K 35/00; G02B 5/26

(52) U.S. Cl. CPC G02B 27/0101; B60K 35/00; G02B 2027/0118; G02B 5/26; B60K 2370/23; G02B 27/0179

(57) ABSTRACT

Provided is a head-up display having improved properties for heat insulation against external light, without increasing the number of components. Disclosed is a head-up display comprising: a lighting device; a display that is illuminated by the lighting device to emit a display light; and a reflector that reflects the display light. The reflector comprises: a reflective layer formed by layering a plurality of resin films having different refractive indices; an adhesive layer; and a base material to which the reflective layer is bonded via the adhesive layer.

### TECHNICAL FIELD

The present disclosure relates to a head-up display.

### BACKGROUND ART

Head-up displays have been used which project display light emitted from a liquid crystal display onto a windshield of a vehicle and display a virtual image in front of the windshield. In this type of head-up display, external light, such as sunlight, enters through an exit port where display light is emitted, and therefore, suppression of damage of a liquid crystal display heated by the external light is required.

Therefore, Patent Document 1 discloses a head-up display employing a cold mirror, which reflects visible light and allows infrared light to pass, as a flat mirror to prevent a liquid crystal display from being heated by sunlight which penetrates into a housing and which is reflected by the flat mirror. However, the head-up display of Patent Document 1 may not prevent a visible light component of sunlight from reflecting off the cold mirror and heading toward the liquid crystal display.

Patent Document 2 discloses a head-up display including a hot mirror (which reflects visible light and absorbs infrared light), a retardation plate, and a polarizing plate which are installed in front of a liquid crystal display. According to such a head-up display, it is possible to prevent a liquid crystal display from being heated by a visible light component or infrared light of sunlight that may not be cut by a cold mirror.

### PRIOR ART DOCUMENT

### Patent Document

Patent Document 1: Japanese Patent No. 4841815

Patent Document 2: Japanese Unexamined Patent Application Publication No. 2013-174855

### SUMMARY OF THE INVENTION

### Problems to be Solved by the Invention

However, the head-up display of Patent Document 2 requires addition of a hot mirror, a retardation plate, and a polarizing plate in front of the liquid crystal display, and therefore, there arises a problem in that the number of components is increased.

Therefore, it is an object of the present disclosure to provide a head-up display having an enhanced heat-shielding property against external light without increasing the number of components.

### Solution to Problem

According to an aspect of the present disclosure, a head-up display includes a lighting device (6), a display (3) which emits display light when being illuminated by the lighting device (6), and a reflector (4) which reflects the display light. The reflector (4) includes a reflective layer (41) including a plurality of layers of resin films having different refractive indices, an adhesive layer (42), and a base material (43) to which the reflective layer (41) is bonded via the adhesive layer (42).

### Effect of the Invention

According to the present disclosure, a heat-shielding property against external light may be enhanced without increasing the number of components.

### BRIEF DESCRIPTION OF THE DRAWINGS

FIG. 1A is a top perspective view of an internal configuration of a head-up display according to an embodiment.

FIG. 1B is a diagram schematically illustrating a head-up display mounted on a vehicle in a lateral view of the vehicle.

FIG. 2 is a cross-sectional view of a reflector according to a first embodiment.

FIG. 3 is a diagram illustrating an action of the reflector.

FIG. 4 is a cross-sectional view of a reflector according to a second embodiment.

FIG. 5 is a cross-sectional view of a reflector according to a third embodiment.

FIG. 6 is a cross-sectional view of a reflector according to a fourth embodiment.

FIG. 7 is a cross-sectional view of a reflector according to a fifth embodiment.

FIG. 8 is a cross-sectional view of a reflector according to a sixth embodiment.

FIG. 9 is an interior side view of a vertical fold type head-up display.

### MODE FOR CARRYING OUT THE INVENTION

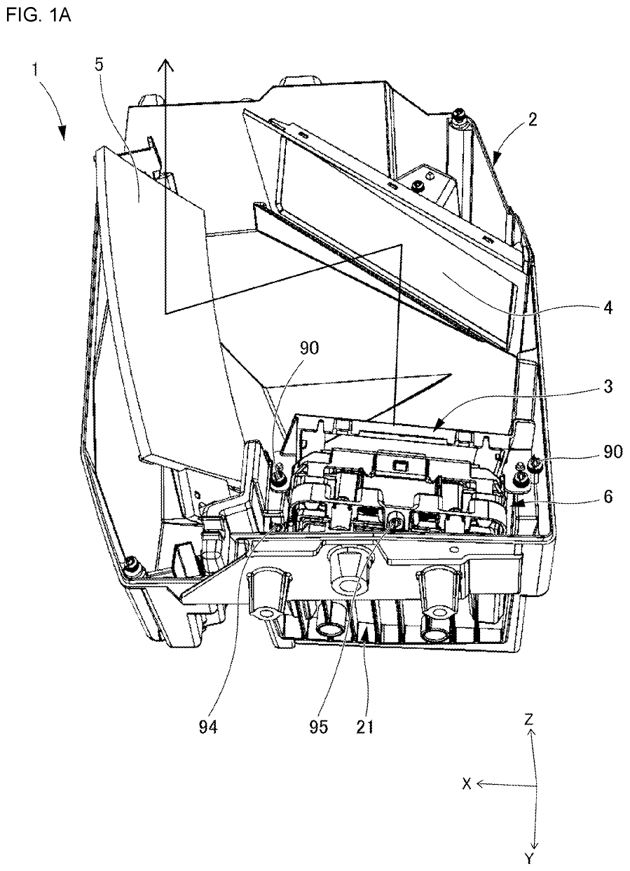

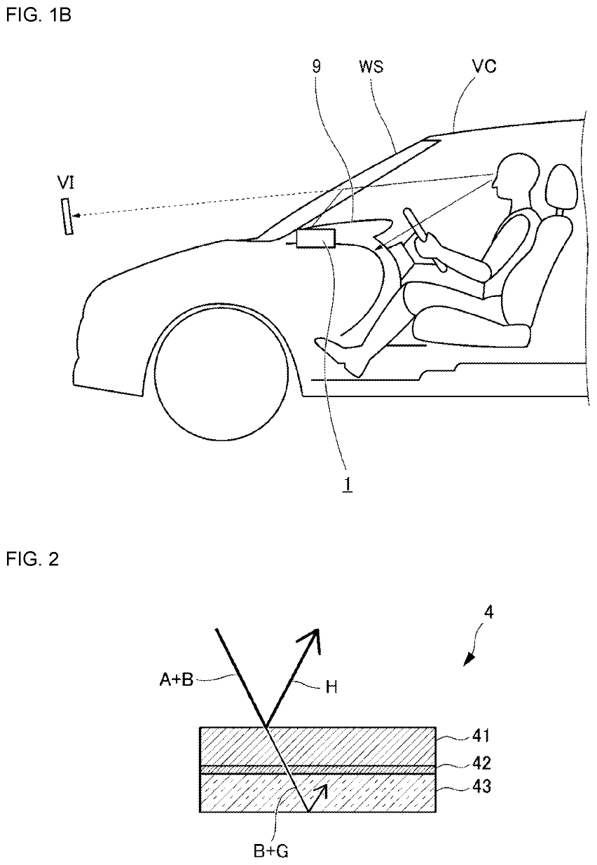

Embodiments will be described in detail below with reference to the accompanying drawings. Note that, in FIG. 1A and other figures, for the sake of clarity, only some of a plurality of parts with the same attribute may be marked with a reference sign.

Configuration of Head-Up Display

FIG. 1A is a top perspective view of an internal configuration of a head-up display 1 according to an embodiment. FIG. 1B is a diagram schematically illustrating the head-up display 1 mounted on a vehicle in a lateral view of the vehicle. Note that, in FIG. 1A, illustrations of some components of the head-up display 1 are omitted. In FIG. 1A, three mutually orthogonal directions, that is, X, Y, and Z directions, are defined in the right-handed system. In the following, the Z direction is formally referred to as a vertical direction, with a positive side being an upper side and a negative side being a lower side.

The head-up display 1 is mounted in an instrument panel 9 of the vehicle. The head-up display 1 may be mounted in such an orientation that the Y direction in FIG. 1A substantially corresponds to a vehicle width direction.

The head-up display 1 includes a case 2, a TFT (Thin Film Transistor) panel unit 3 (an example of a display), a reflector 4, a concave mirror 5, and a backlight unit 6 (an example of a lighting device).

The case 2 forms a housing of the head-up display 1. The case 2 is a lower case which forms a lower portion of the housing of the head-up display 1. The case 2 is coupled to an upper case not shown in FIG. 1A.

The case 2 is formed of material with high heat conductivity, such as aluminum. The case 2 includes a heat dissipation portion 21 as shown in FIG. 1A. The heat dissipation portion 21 is formed on an outer surface (a surface exposed to an outside) of the case 2. The heat dissipation portion 21 has a function to dissipate heat generated in the backlight unit 6. The heat dissipation portion 21 dissipates heat to the air flowing outside the case 2.

The TFT panel unit 3 is a display which uses light emitted from the backlight unit 6 as backlight to emit display light for a display image. The TFT panel unit 3 in this embodiment includes a dot-matrix TFT (Thin Film Transistor) panel. The display image is an arbitrary image and may be an image representing, for example, navigation information or various vehicle information.

The TFT panel unit 3 is fixed to the case 2. For example, the TFT panel unit 3 is fastened by screws 90 at two portions on both sides in the X direction as shown in FIG. 1A.

The reflector 4 reflects the display light emitted from the TFT panel unit 3 toward the concave mirror 5.

The concave mirror 5 reflects the display light reflected by the reflector 4 and causes the display light to be emitted from an exit port formed on an upper case (not shown) and directed to a windshield WS of a vehicle VC. The concave mirror 5 may be supported with respect to the case 2 in a rotation available manner so that a vertical position of an area where the display light hits in the windshield WS is adjustable.

As shown in FIG. 1B, when the windshield WS is irradiated with the display light, a driver of the vehicle VC can see a display image (imaginary display) VI obtained by the irradiation in front of the windshield WS. Accordingly, the driver can see the display image VI superimposed on scenery in front of the driver, and can recognize vehicle information and the like in a manner that requires less eye movement, thereby improving convenience and safety.

The backlight unit 6 is disposed behind the TFT panel unit 3 (on a negative side in the Y direction). The backlight unit 6 generates display light in cooperation with the TFT panel unit 3.

Configuration of Reflector

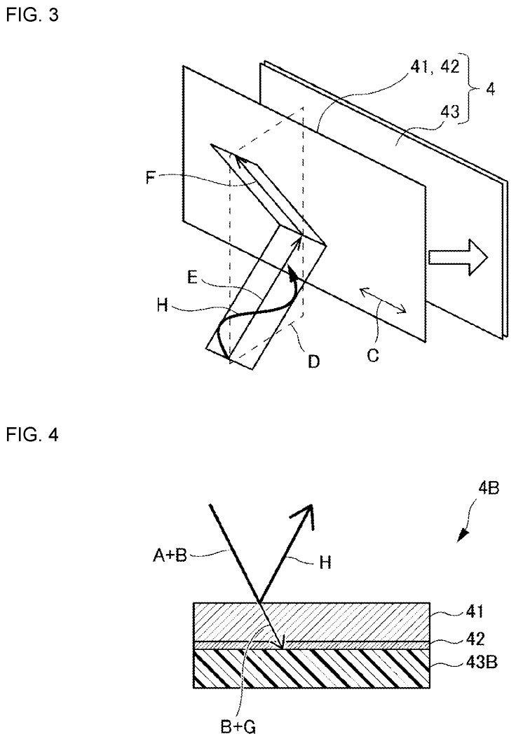

Next, a configuration of the reflector 4 will be described with reference to FIGS. 2 and 3.

FIG. 2 is a cross-sectional view of a reflector 4 according to a first embodiment. FIG. 3 is a diagram illustrating an action of the reflector 4.

As shown in FIG. 2, the reflector 4 of the first embodiment has a reflective layer 41, an adhesive layer 42, and a base material 43 to which the reflective layer 41 is bonded via the adhesive layer 42. The reflective layer 41 faces the TFT panel unit 3 and the concave mirror 5. The adhesive layer 42 and the base material 43 are formed behind the reflective layer 41.

The reflective layer 41 is a reflective polarizing multilayer film. The reflective polarizing multilayer film includes hundreds of layers of polyester resin films having different refractive indices.

In the reflective layer 41, refractive indices of the individual films are adjusted so as to reflect only a specific polarization component of visible light A. The reflective layer 41 has wavelength selectivity for reflected wavelengths and does not reflect infrared light B but allows the infrared light B to pass. The reflective layer 41 has a reflection axis and reflects a linearly polarized component of the visible light A which is parallel to a reflection axis direction C. The reflective layer 41 does not reflect the linearly polarized component of the visible light A which is perpendicular to the reflection axis direction C but allows the linearly polarized component of the visible light A which is perpendicular to the reflection axis direction C to pass. A detailed description will be made with reference to FIG. 3. When the reflection axis direction C of the reflective layer 41 is parallel to a direction orthogonal to an incident plane D (a plane formed by incident light E and reflection light F), the reflective layer 41 allows P-polarized light G (not shown) of the visible light A, which is a wave component parallel to the incident plane D, to pass. Furthermore, the reflective layer 41 reflects S-polarized light H of the visible light A, which is a wave component orthogonal to the incident plane D.

Accordingly, the reflector 4 having the reflective layer 41 allows the infrared light B to pass so as to prevent the infrared light B from reaching the TFT panel unit 3 in external light, such as sunlight, incident from the outside. Since the reflective layer 41 reflects only the S-polarized light H and allows the P-polarized light G to pass in the visible light A included in the external light, the visible light directed toward the TFT panel unit 3 may be reduced without arranging a glass plate with a polarizing film or the like in the vicinity of the TFT panel unit 3.

The adhesive layer 42 is made of acrylic resin and is a colorless transparent adhesive layer. The reflective layer 41 and the adhesive layer 42 are provided as a single component, a total thickness of which is approximately 60 μm.

The base material 43 is a member that holds the reflective layer 41 in excellent flatness and excellent planeness and has both vibration resistance and transparency. Examples of the base material 43 include transparent inorganic glass. Considering economy and rigidity, inorganic glass having a thickness in a range from 1.7 mm to 2.1 mm is employed as the reflector 4 of the head-up display 1.

Arrangement of Reflector

The reflector 4 is arranged in such an orientation that the reflection axis direction C of the reflective layer 41 is substantially parallel to a polarization direction of the display light emitted from the TFT panel unit 3. By arranging the reflector 4 in this manner, the display light emitted from the TFT panel unit 3 can be reflected in a direction of an occupant's viewpoint with less attenuation of the display light while the visible light A directed to the TFT panel unit 3 is reduced.

For example, the head-up display 1 of the present example shown in FIG. 1A is a so-called horizontal fold type in which the reflector 4 reflects the display light emitted from the TFT panel unit 3 in a horizontal direction (a direction closer to the horizontal direction than the vertical direction). Accordingly, the reflector 4 is arranged in such an orientation that the incident plane D of the display light emitted from the TFT panel unit 3 is closer to a horizontal plane than to a vertical plane and that the reflection axis direction C of the reflective layer 41 is substantially parallel to the direction orthogonal to the incident plane D. Specifically, the reflector 4 is arranged in such an orientation that the reflection axis direction C of the reflective layer 41 is a vertical direction (a direction closer to the vertical direction than the horizontal direction).

An angle of incidence of the display light emitted from the TFT panel unit 3 to the reflector 4 is preferably in a range from 30° to 40°. In this way, the concave mirror 5 and the TFT panel unit 3 can be arranged in close proximity so that the head-up display 1 can be miniaturized.

Other Embodiments of Reflector

Next, reflectors 4B, 4C, 4D of second to fourth embodiments will be described with reference to FIGS. 4 to 6. However, for components common to the first embodiment, the description of the first embodiment is incorporated by using the same reference numerals as in the first embodiment.

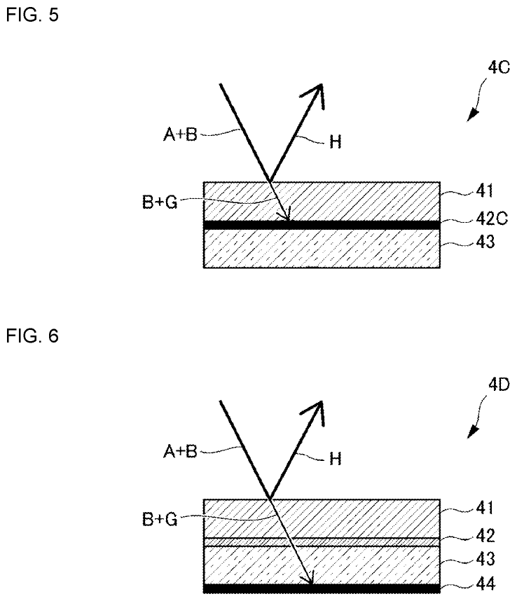

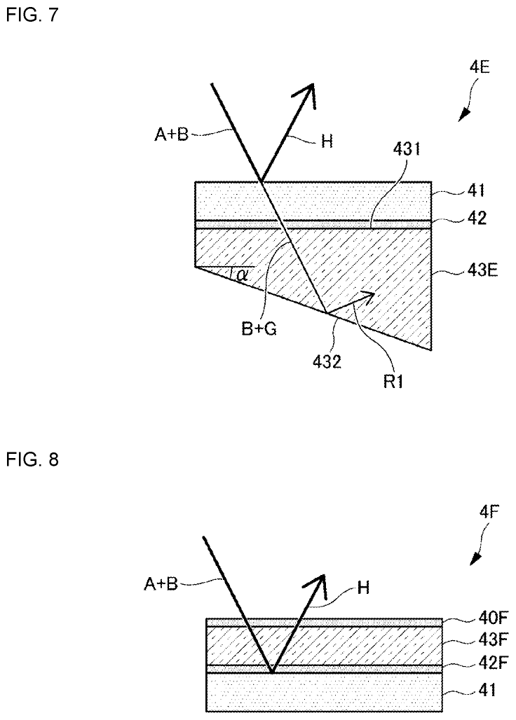

FIG. 4 is a cross-sectional view of the reflector 4B according to the second embodiment. FIG. 5 is a cross-sectional view of the reflector 4C according to the third embodiment. FIG. 6 is a cross-sectional view of the reflector 4D according to the fourth embodiment. FIG. 7 is a cross-sectional view of a reflector 4E according to a fifth embodiment. FIG. 8 is a cross-sectional view of a reflector 4F according to a sixth embodiment. In the following, a term “front side” of the reflector 4F corresponds to an incident side of light (e.g., display light emitted from the TFT panel unit 3) to the reflector 4F.

According to the reflector 4 of the first embodiment described above, the P-polarized light G of the infrared light B and the visible light A included in the external light, such as sunlight, is prevented from being directed toward the TFT panel unit 3, thereby enhancing a heat-shielding property against the external light. However, in the reflector 4 of the first embodiment, as shown in FIG. 2, a portion of the light (the infrared light B and the P-polarized light G) transmitted through the reflective layer 41 may be reflected at a back surface of the base material 43 and transmitted through the reflective layer 41 again to the TFT panel unit 3. Temperature rise of the TFT panel unit 3 due to such re-transmitted light may reach approximately 10° C. at sunlight of 1000 W/m2. When a retaining member of the reflector 4 is irradiated with the light transmitted through the reflective layer 41, molding of the retaining member may be reflected in the display image.

As shown in FIG. 4, in the reflector 4B of the second embodiment, a base material 43B has a light-shielding property. The base material 43B having the light-shielding property is not colorless or transparent but colored, and is composed of, for example, a black resin plate. According to the reflector 4B described above, the light transmitted through the reflective layer 41 is absorbed by the base material 43B so that a heat-shielding effect by the reflector 4B may be enhanced. Furthermore, the base material 43B having the light-shielding property can also prevent molding of the retaining member of the reflector 4B from being reflected in the display image.

As shown in FIG. 5, in the reflector 4C of the third embodiment, an adhesive layer 42C has a light-shielding property. The adhesive layer 42C having the light-shielding property is not colorless or transparent but colored, and is composed of, for example, a black adhesive. According to the reflector 4C described above, the same effect as that of the reflector 4B of the second embodiment may be obtained.

As shown in FIG. 6, the reflector 4D of the fourth embodiment includes a light-shielding layer 44 having a light-shielding property on a back surface of a base material 43 (a surface opposite to a reflective layer 41). The light-shielding layer 44 includes a printing layer which is not colorless or transparent but is printed with colored ink, and a colored adhesive film. According to the reflector 4D described above, the same effect as that of the reflector 4B of the second embodiment may be obtained. When the light-shielding layer 44 is composed of the printing layer, black oil-based ink or UV-curable ink having a refractive index close to that of the base material 43 is preferably used. When the light-shielding layer 44 is composed of an adhesive film, a black adhesive film is preferably used that is attached via an adhesive having a refractive index close to that of the base material 43. This configuration reduces a reflectance at a boundary surface between the base material 43 and the light-shielding layer 44 so that the light transmitted through the reflective layer 41 may be reliably absorbed by the light-shielding layer 44.

As shown in FIG. 7, the reflector 4E of the fifth embodiment is different from the reflector 4 of the first embodiment in that the base material 43 is replaced by a base material 43E. The base material 43E has a different cross-sectional shape and is formed of the same material with respect to the base material 43 of the reflector 4 of the first embodiment. Specifically, in the base material 43E, a first surface 431 (i.e., a surface on an incident side of the display light) in contact with an adhesive layer 42 and a second surface 432 on an opposite side of the first surface 431 are non-parallel. In other words, the base material 43E has a wedge-shaped cross section. Furthermore, the base material 43E does not have a constant thickness in the cross-sectional view (i.e., the view shown in FIG. 7) cut by an incident plane D of the display light (a plane formed by incident light E and reflection light F).

In the example shown in FIG. 7, the first surface 431 and the second surface 432 are both planar and form an angle of α. The formed angle α is arbitrarily determined as long as the angle is significantly greater than 0 and significantly less than 90 degrees. The formed angle α may be set such that a traveling direction of reflection light R1, which will be described below, is a desired direction (a desired direction within a range that is not toward the TFT panel unit 3).

According to the reflector 4E of the fifth embodiment, as in the first to fourth embodiments described above, a reflective layer 41 including a plurality of resin films having different refractive indices may allow infrared light B in external light, such as sunlight, incident from the outside to pass so as to prevent the infrared light B from reaching the TFT panel unit 3. Since the reflective layer 41 reflects only S-polarized light H and allows P-polarized light G to pass in visible light A included in the external light, the visible light directed toward the TFT panel unit 3 may be reduced without arranging a glass plate with a polarizing film or the like in the vicinity of the TFT panel unit 3. In this way, the reflector 4E of the fifth embodiment can also enhance the heat-shielding property against the external light without increasing the number of components, as in the first to fourth embodiments described above.

According to the reflector 4E of the fifth embodiment, even when a part of the light (infrared light B and P-polarized light G) transmitted through the reflective layer 41 is reflected on the second surface 432 of the base material 43, the reflection light R1 is not parallel to S-polarized light H, as schematically shown in FIG. 7. Since the reflection light R1 is not parallel to the S-polarized light H, even when the reflection light R1 is transmitted through the reflective layer 41 again, the possibility that the reflection light R1 is directed to the TFT panel unit 3 as retransmitted light as described above is low. Accordingly, according to the reflector 4E of the fifth embodiment, the above-described disadvantage (e.g., temperature rise of the TFT panel unit 3) caused by the reflection light R1 reflected at the second surface 432 may be reduced.

Note that the fifth embodiment can be combined with the differences of the second to fourth embodiments described above relative to the first embodiment described above. For example, the base material 43E may have a light-shielding property, as in the base material 43B of the reflector 4B of the second embodiment, the adhesive layer 42 may have a light-shielding property, as in the reflector 4C of the third embodiment, or the second surface 432 (back surface) of the base material 43E may include a light-shielding layer 44, as in the reflector 4D of the fourth embodiment.

Furthermore, although the second surface 432 is planar in the fifth embodiment, the second surface 432 may include curved portions. Moreover, the second surface 432 may be realized by a combination of a plurality of planes. In this case, the plurality of planes may all be non-parallel to the first surface 431, or only one of the plurality of planes may be parallel to the first surface 431.

As shown in FIG. 8, the reflector 4F of the sixth embodiment is different from the reflector 4 of the first embodiment in that a reflective layer 41 is disposed on the back side. That is, in the reflector 4 of the first embodiment (the same applies to the second to fifth embodiments), the reflective layer 41 is disposed on the incident side of the display light relative to the base material 43, whereas in the reflector 4F of the sixth embodiment, the base material 43F is disposed on the incident side of the display light relative to the reflective layer 41.

Specifically, the reflector 4F of the sixth embodiment includes, from the front side, a surface layer 40F, a base material 43F, an adhesive layer 42F, and a reflective layer 41. The layers on the front side relative to the reflective layer 41 have translucency. That is, the surface layer 40F, the base material 43F, and the adhesive layer 42F have translucency. As a result, even when the reflective layer 41 is disposed on the back side, the same function as the reflective layer 41 of the first to fifth embodiments described above may be realized.

The surface layer 40F is a coating layer formed by coating, such as an overcoat, for example. The surface layer 40F may be formed by applying various translucent resins, such as polyimide, acrylic, and epoxy, in a form of a film. The adhesive layer 42F is a translucent adhesive layer which is colorless and transparent and may be the same as the adhesive layer 42 of the reflector 4 of the first embodiment. The base material 43F may be formed, for example, by transparent inorganic glass. In this case, the base material 43F may have the same configuration as the base material 43 of the reflector 4 of the first embodiment.

According to the reflector 4F of the sixth embodiment, as in the first to fifth embodiments described above, the reflective layer 41 including a plurality of resin films having different refractive indices may allow infrared light B in external light, such as sunlight, incident from the outside to pass so as to prevent the infrared light B from reaching the TFT panel unit 3. Since the reflective layer 41 reflects only the S-polarized light H and allows the P-polarized light G to pass in the visible light A included in the external light, the visible light directed toward the TFT panel unit 3 may be reduced without arranging a glass plate with a polarizing film or the like in the vicinity of the TFT panel unit 3. In this way, the reflector 4F of the sixth embodiment can also enhance the heat-shielding property against external light without increasing the number of components, as in the first to fourth embodiments described above.

According to the reflector 4F of the sixth embodiment, since the reflective layer 41 is not located on the most front side of the reflector 4F, the possibility of damage to the reflective layer 41 (e.g., damage that may occur when an object hits the reflector 4F during assembly) may be reduced. That is, according to the reflector 4F of the sixth embodiment, the base material 43F and the surface layer 40F may function as a protective layer for protecting the reflective layer 41.

Note that, although the surface layer 40F is disposed on the front side of the base material 43F in the sixth embodiment so as to protect the base material 43F, the present disclosure is not limited to this. Specifically, the surface layer 40F may be omitted.

Application to Vertical Fold Type Head-Up Display

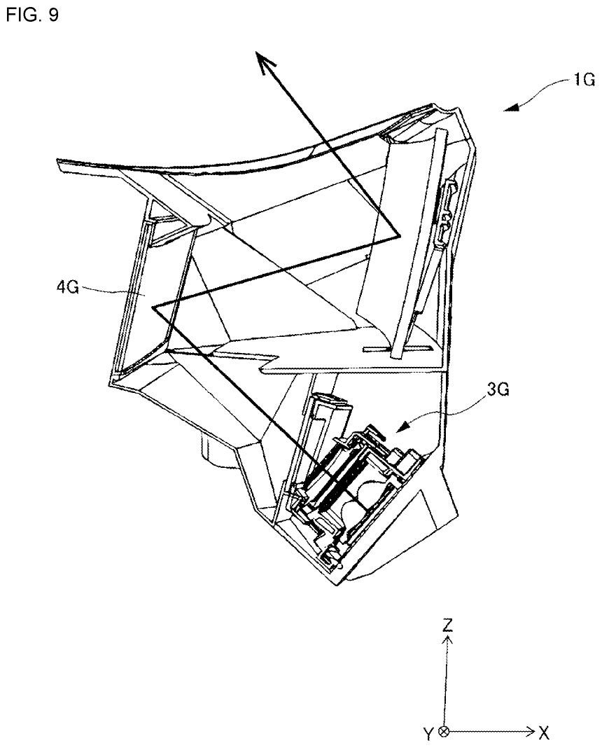

Next, a case where the reflector 4 (including the reflectors 4B, 4C, and 4D) of the above-described embodiments is applied to the reflector 4G of a so-called vertical fold type head-up display 1G will be described with reference to FIGS. 3 and 9.

FIG. 9 is an interior side view of the vertical fold type head-up display 1G.

In the vertical fold type head-up display 1G shown in FIG. 9, the reflector 4G reflects display light emitted from a TFT panel unit 3G in a vertical direction (closer to the vertical direction than the horizontal direction). Accordingly, the reflector 4G is arranged in such an orientation that an incident plane D of the display light emitted from the TFT panel unit 3G is closer to a vertical plane than to a horizontal plane and that the reflection axis direction C of the reflective layer 41 is substantially parallel to a direction orthogonal to the incident plane D. Specifically, the reflector 4G is disposed in such an orientation that the reflection axis direction C of the reflective layer 41 is a horizontal direction (a direction closer to the horizontal direction than the vertical direction). According to such an arrangement of the reflector 4G, the same effect as that of the above-described horizontal fold type head-up display 1 may be obtained.

Although the embodiments have been described in detail above, the present disclosure is not limited to the specific embodiments, and various modifications and changes may be made within the scope of the claims. Furthermore, all or a number of the components of the foregoing embodiments described above may be combined.

For example, although the concave mirror 5 is disposed in the foregoing embodiments, the concave mirror 5 may be omitted.

The following appendices are disclosed in connection with the embodiments described above.

Appendix 1

A head-up display (1) includes a lighting device (6), a display (3) which emits display light when being illuminated by the lighting device (6), and a reflector (4) which reflects the display light. The reflector (4) includes a reflective layer (41) including a plurality of layers of resin films having different refractive indices, an adhesive layer (42), and a base material (43) to which the reflective layer (41) is bonded via the adhesive layer (42).

Appendix 2

In the head-up display according to Appendix 1, at least one of the base material (43) and the adhesive layer (42) has a light-shielding property.

Appendix 3

In the head-up display according to Appendix 1, the base material (43) includes a light-shielding layer (44) having a light-shielding property on a surface opposite to the reflective layer (41).

Appendix 4

In the head-up display according to appendix 3, the light-shielding layer (44) is formed by UV-cured ink or black oil-based ink.

Appendix 5

In the head-up display according to any one of Appendices 1 to 4, the reflector (4) is disposed in such an orientation that a reflection axis direction (C) of the reflective layer (41) is substantially parallel to a polarization direction of the display light emitted from the display (3).

Appendix 6

In the head-up display according to Appendix 1, the base material (43) is disposed on an incident side of the display light relative to the reflective layer (41).

Appendix 7

In the head-up display according to any one of Appendices 1 to 6, the reflector (4) is disposed in such an orientation that the reflection axis direction (C) of the reflective layer (41) is substantially parallel to the polarization direction of the display light emitted from the display (3).

Appendix 8

In the head-up display according to Appendix 7, the reflector (4) is disposed in such an orientation that an incident plane (D) of the display light emitted from the display (3) is closer to a horizontal plane than to a vertical plane and that the reflection axis direction (C) of the reflective layer (41) is substantially parallel to a direction orthogonal to the incident plane (D).

In this case, the display may emit S-polarized display light, and the reflector may have an S-polarized reflectance higher than a P-polarized reflectance.

Appendix 9

In the head-up display according to Appendix 7, the reflector (4) is disposed in such an orientation that an incident plane (D) of the display light emitted from the display (3) is closer to a vertical plane than to a horizontal plane and that the reflection axis direction (C) of the reflective layer (41) is substantially parallel to a direction orthogonal to the incident plane (D).

In this case, the display may emit S-polarized display light, and the reflector may have an S-polarized reflectance higher than a P-polarized reflectance.

Appendix 10

In the head-up display according to any one of Appendices 1 to 5 and 7 to 9, the base material (43) has a first surface (431) in contact with the adhesive layer (42) and a second surface (432) on a back side of the first surface (431), the first surface (431) being non-parallel to the second surface (432).

### DESCRIPTION OF REFERENCE NUMERALS

1, 1G Head-up display

2 Case

3, 3G TFT panel unit

4, 4B, 4C, 4D, 4E, 4F, 4G Reflector

5 Concave mirror

6 Backlight Unit

9 Instrument panel

21 Heat dissipation portion

41 Reflective layer

42, 42C, 42F Adhesive layer

43, 43B, 43E, 43F Base material

44 Light-shielding layer

90 Screw

A Visible light

B Infrared light

C Reflection axis direction

D Incident plane

E Incident light

F Reflection light

G P-Polarized light

H S-Polarized light

1. A head-up display, comprising:
a lighting device;
a display which emits display light when being illuminated by the lighting device; and
a reflector which reflects the display light,
wherein the reflector includes a reflective layer including a plurality of layers of resin films having different refractive indices, an adhesive layer, and a base material to which the reflective layer is bonded via the adhesive layer.

2. The head-up display according to claim 1, wherein at least one of the base material and the adhesive layer has a light-shielding property.

3. The head-up display according to claim 1, wherein the base material includes a light-shielding layer having a light-shielding property on a surface opposite to the reflective layer.

4. The head-up display according to claim 1, wherein the reflector is disposed in such an orientation that a reflection axis direction of the reflective layer is substantially parallel to a polarization direction of the display light emitted from the display.

5. The head-up display according to claim 4, wherein the reflector is disposed in such an orientation that an incident plane of the display light emitted from the display is closer to a horizontal plane than to a vertical plane and that the reflection axis direction of the reflective layer is substantially parallel to a direction orthogonal to the incident plane.

6. The head-up display according to claim 1, wherein the base material is disposed on an incident side of the display light relative to the reflective layer.

7. The head-up display according to claim 1, wherein the reflector is disposed in such an orientation that the reflection axis direction of the reflective layer is substantially parallel to a polarization direction of the display light emitted from the display.

8. The head-up display according to claim 7, wherein the reflector is disposed in such an orientation that the incident plane of the display light emitted from the display is closer to a horizontal plane than to a vertical plane and that the reflection axis direction of the reflective layer is substantially parallel to the direction orthogonal to the incident plane.

9. The head-up display according to claim 7, wherein the reflector is disposed in such an orientation that the incident plane of the display light emitted from the display is closer to a vertical plane than to a horizontal plane and that the reflection axis direction of the reflective layer is substantially parallel to the direction orthogonal to the incident plane.

10. The head-up display according to claim 1, wherein the base material has a first surface in contact with the adhesive layer and a second surface on a back side of the first surface, the first surface being non-parallel to the second surface.
